(19) United States
(12) Patent Application Publication
(10) Pub. No.: US 2022/0041325 A1
(43) Pub. Date: Feb. 10, 2022

(54) CONTAINER AND METHOD OF MANUFACTURING THE SAME

(71) Applicants: Raymond Columbus Simmons, Chapel Hill, NC (US); Benjamin Simmons, Chapel Hill, NC (US)

(72) Inventors: Raymond Columbus Simmons, Chapel Hill, NC (US); Benjamin Simmons, Chapel Hill, NC (US)

(21) Appl. No.: 17/385,121

(22) Filed: Jul. 26, 2021

Related U.S. Application Data
(60) Provisional application No. 63/060,907, filed on Aug. 4, 2020.

(51) Int. Cl. B65D 5/56; B65D 25/14; B65D 65/40; B31B 50/74

(52) U.S. Cl. CPC B65D 5/563; B65D 25/14; B31B 2120/40; B31B 50/742; B65D 2565/385; B65D 65/403

(57) ABSTRACT

Various embodiments are directed to repulpable and recyclable container comprising an outer liner, an inner liner, a sidewall medium arranged between the outer liner and the inner liner, the sidewall medium being defined at least in part by a sidewall flute, and one or more coating layers adhered to one or more of a first outer liner surface, a second outer liner surface, a first inner liner surface, and a second inner liner surface; wherein the container is configured such that the flute is adhered to the outer liner and the inner liner via at least one volume of adhesive configured to directly engage at least a portion of the one or more coating layers. Various embodiments are directed to a container manufacturing system configured to produce a repulpable and recyclable container. Various embodiments are directed to a method of manufacturing a repulpable and recyclable container.

### CROSS-REFERENCES TO RELATED APPLICATION(S)

The present application claims priority to U.S. Provisional Patent Application No. 63/060,907, titled “CONTAINER AND METHOD OF MANUFACTURING THE SAME,” filed Aug. 4, 2020, which is incorporated herein by reference in its entirety.

### FIELD OF THE INVENTION

Various embodiments described herein relate generally to a repulpable and recyclable container. In particular, various embodiments are directed to a repulpable and recyclable container comprising at least one water-resistant coating layer applied to one or more liners.

### BACKGROUND

Industrial and commercial applications may use containers to display, store, and ship various food items such as meat or produce. In particular, a container may be configured to be repulpable and recyclable to minimize waste and increase the efficiency of the disposal process associated with the container. Through applied effort, ingenuity, and innovation, Applicant has solved problems relating to repulpable and recyclable containers by developing solutions embodied in the present disclosure, which are described in detail below.

### BRIEF SUMMARY

Various embodiments are directed to a repulpable and recyclable container and method of using the same. In various embodiments, a repulpable and recyclable container may comprise an outer liner comprising a first outer liner surface and a second outer liner surface; an inner liner comprising a first inner liner surface and a second inner liner surface; a sidewall medium arranged between the second outer liner surface and the second inner liner surface, the sidewall medium being defined at least in part by a sidewall flute; and one or more coating layers adhered to one or more of the first outer liner surface, the second outer liner surface, the first inner liner surface, and the second inner liner surface; wherein the container is configured such that the flute is adhered to the outer liner and the inner liner via at least one volume of adhesive configured to directly engage at least a portion of the one or more coating layers.

In various embodiments, the one or more coating layers may comprise a plurality of coating layers adhered to each of the first outer liner surface, the second outer liner surface, the first inner liner surface, and the second inner liner surface. In various embodiments, at least a portion of the one or more coating layers may be defined at least in part by a coating layer thickness of between 0.1 lbs/MBF and 5 lbs/MBF. In various embodiments, at least a portion of the one or more coating layers may be defined at least in part by a coating layer thickness, and wherein a ratio of the coating layer thickness to a liner thickness is at least approximately between 1:20 and 1:1.

In various embodiments, a container may further comprise one or more flute coating layers applied to at least a portion of the sidewall flute. In various embodiments, the at least one volume of adhesive may be further configured to directly engage at least a portion of the one or more flute coating layers. In certain embodiments, the at least one volume of adhesive may comprise a non-starch-based adhesive. In various embodiments, at least a portion of the one or more coating layers may comprise a polymeric material.

Various embodiments are directed to a container manufacturing system configured to produce a repulpable and recyclable container, the system comprising: a container production assembly configured to produce a repulpable and recyclable container comprising: an outer liner comprising a first outer liner surface and a second outer liner surface; an inner liner comprising a first inner liner surface and a second inner liner surface; a sidewall medium arranged between the second outer liner surface and the second inner liner surface, the sidewall medium being defined at least in part by a sidewall flute; and one or more coating layers adhered to one or more of the first outer liner surface, the second outer liner surface, the first inner liner surface, and the second inner liner surface; wherein the container is configured such that the flute is adhered to the outer liner and the inner liner via at least one volume of adhesive configured to directly engage at least a portion of the one or more coating layers.

Various embodiments are directed to a method of manufacturing a repulpable and recyclable container comprising applying a first outer coating layer to a first outer liner surface and a second outer coating layer to a second outer liner surface; applying a first inner coating layer to a first inner liner surface and a second inner coating layer to a second inner liner surface; applying at least one volume of adhesive to one or more of the second outer liner surface, the second inner liner surface and the sidewall flute; and curing at least a portion of the at least one volumes of adhesive so as to secure at least a portion of the sidewall flute relative to the second outer liner surface and the second inner liner surface.

In various embodiments, the method may further comprise applying a flute coating layer to at least a portion of a sidewall flute configured to be arranged at least substantially between the second outer liner surface and the second inner liner surface. In various embodiments, applying at least one volume of adhesive to one or more of the second outer liner surface, the second inner liner surface and the sidewall flute may comprise applying a volume of adhesive to at least a portion of a plurality of flute surface contact portions. In certain embodiments, the at least a portion of a plurality of flute surface contact portions may comprise one or more outer flute surface contact portions defined by an outer flute surface of the sidewall flute. Further, in certain embodiments, the at least a portion of a plurality of flute surface contact portions may comprise one or more inner flute surface contact portions defined by an inner flute surface of the sidewall flute. In various embodiments, the method may further comprise curing the first outer coating layer and the second outer coating layer. Further, in various embodiments, the method may further comprise curing the first inner coating layer and the second inner coating layer.

### BRIEF DESCRIPTION OF THE DRAWINGS

Reference will now be made to the accompanying drawings, which are not necessarily drawn to scale, and wherein:

FIGS. 1A-1B illustrate cross-sectional views of exemplary repulpable and recyclable components according to various embodiments.

FIGS. 2A-2B illustrate various cross-sectional views of exemplary repulpable and recyclable containers according to various embodiments.

FIGS. 3A-3B schematically illustrate exemplary container manufacturing systems in accordance with various embodiments.

FIG. 4 illustrates a flow diagram of an exemplary method of manufacturing a repulpable container in accordance with various embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

Various containers may be used to display, ship, and/or store items such as perishable meat or produce items. Traditional containers used for shipping perishable food products such as produce may comprise corrugated paperboard products and may be exposed to moisture throughout the shipping process. Where moisture can compromise the structural integrity of a corrugated box, those skilled in the art typically apply a coat of wax to those boxes likely to carry liquid-bearing cargo, so as to eliminate or at least minimize the box's exposure to moisture, and thus prevent its destruction and/or deterioration. Typically, a wax coating is applied to the above-referenced boxes by simply melting max and using one of the methods known in the art to coat the surfaces of the box likely to interact with moisture with the melted wax. As a non-limiting example, in the shipping industry, such coated boxes are often used to transport produce or other items across the country for weeks at a time. Notably, associated shipping costs are greatly influenced by the total weight of the package (box and contents included) being shipped. Further, wax and other traditional coating materials may frequently represent hurdles to the disposal processes and/or waste minimization efforts associated with containers treated with such material.

Traditional industry standards used to assess the efficiency with which a container may be disposed include assessing the recyclability and the repulpability of the container material. As described herein, “recyclable” may refer to used paper, including in-plant and post-consumer waste paper and paperboard, which is capable of being processed into new paper or paperboard using the process defined in this standard. As described herein, “repulpable” may refer to a material configured to undergo the operation of re-wetting and fiberizing for subsequent sheet formation, using the process defined in this standard. As described above, containers treated with various coating materials so as to facilitate the container's resistance to moisture frequently fail to satisfy industry standards of recyclability and repulpability. As one example, treating a container, by a cascade wax application method, with a coating layer of a paraffin wax that is sufficiently robust so as to minimize the exposure of the container to moisture may reduce and/or effectively prevent the repulpability of the container.

Therefore, where it may be desirable for a container to be classified as repulpable and recyclable while embodying a substantially water-resistant configuration, a need exists for containers and methods of manufacturing the same configured to effectively and efficiently produce a recyclable, repulpable, and substantially water-resistant container configured to maintain a desirable degree of strength and performance conventionally achieved by traditional container configurations. Further, where it may be desirable to minimize the weight of the one or more coating materials applied to a repulpable, recyclable, and substantially water-resistant container, and the manufacturing time associated with producing such a container, a need exists for an efficient method of producing a recyclable and repulpable container so as to minimize the overall weight of the treated container and the efficiency with which the container is manufactured.

### Overview

Various embodiments of the present invention are directed to a recyclable and repulpable container and a method of manufacturing the same. In various embodiments, an exemplary liner described herein may comprise at least one coating layer configured to facilitate the recyclability and repulpability of the liner, while providing further structural support to the liner such that the structural integrity of the liner may be maintained under various industry-defined crushing loads. In various embodiments, an exemplary container described herein may comprise an outer liner and an inner liner, both of which having at least one coating layer of material applied thereto. For example, the present invention described herein may include a container with coating layers adhered to each of a first outer liner surface and a second outer liner surface of the outer liner, as well as a first inner liner surface and a second inner liner surface of the inner liner. As described herein, the coating layer may comprise a water-resistant material such as, for example, a polymeric material that may be at least substantially impermeable to moisture while supporting the structural integrity, repulpability, and recyclability of the exemplary container. An exemplary liner of the present invention may function to increase one or more strength characteristics of the liner, such that the structural integrity of the liner may be maintained in an exemplary circumstance wherein a volume moisture has penetrated a liner surface and absorbed by the liner material. For example, an exemplary recyclable and repulpable container described herein may represent substantial improvement over a traditional container (e.g., a produce box) with a wax coating layer applied thereto using, for example, a cascade wax application method and/or the like, as the present invention is configured to exhibit strength performance characteristics that at least equal to and/or greater than those of the traditional cascade-wax-coated container, while simultaneously providing a recyclable and repulpable solution.

Further, in various embodiments, one or more coating layers may be similarly applied to one or more surfaces of an exemplary sidewall flute arranged within a sidewall medium between the outer liner and the inner liner. In various embodiments, the sidewall flute may be adhered to the one or more treated liners by, for example, a volume of adhesive. In various embodiments, the composition of the volume of adhesive may be configured so as to facilitate the adhesion of the sidewall flute to a liner of the container in an exemplary embodiment wherein liner surface to which the sidewall flute is configured to be adhered has been treated with a water-resistance coating layer. Further, the composition of the volume of adhesive may be configured to as to facilitate the adhesion of two adjacent water-resistance coating layer adhered to, for example, a liner surface and a flute surface, respectively.

Various embodiments described herein are directed to a container manufacturing system configured to produce an exemplary coated liner and execute various processes of exemplary methods described herein. Further, various embodiments described herein are directed to a container manufacturing system configured to produce an exemplary container and execute various processes of exemplary methods described herein. In various embodiments, the exemplary methods and systems described herein are configured to minimize the production time associated with manufacturing an exemplary repulpable and recyclable liner exhibiting increased strength characteristics, as described herein.

### Exemplary Container

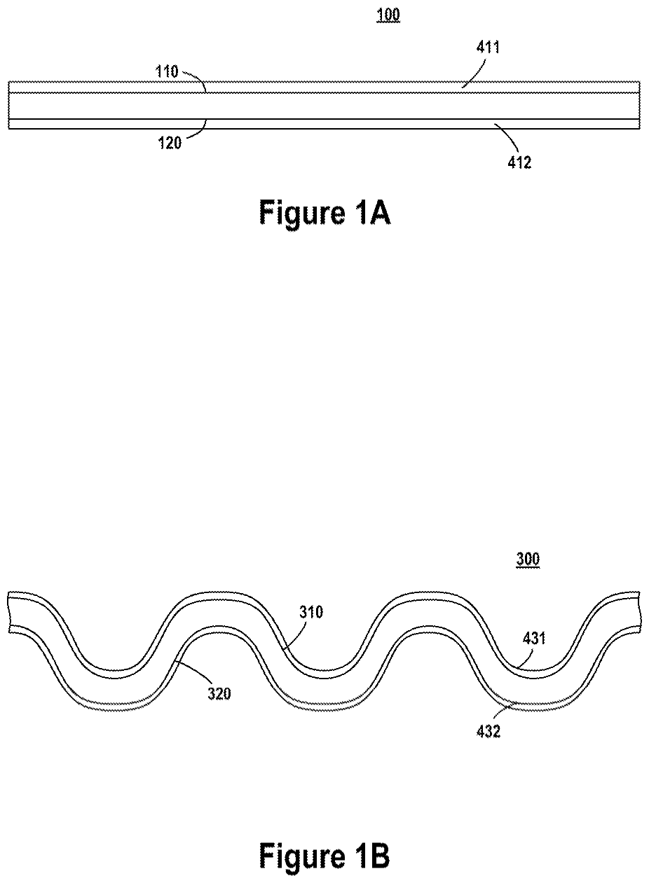

FIGS. 1A-1B illustrate cross-sectional exemplary views of an exemplary container according to various embodiments. In particular, FIG. 1A illustrates a cross-sectional view of an exemplary repulpable and recyclable liner 100 comprising a substantially water-resistant configuration, as described herein. In various embodiments, the liner may comprise a substantially planar potion of semi-rigid material. As described herein, in various embodiments, the outer liner 100 may comprise a liner made from a cellulose-based material such as, for example, wood pulp, cotton, straw, and/or the like. As non-limiting example, the outer liner 100 may comprise cardboard, paperboard, fiberboard, containerboard, and/or the like.

In various embodiments, the exemplary liner 100 may define at least a portion of an exemplary container, such as, for example, one or more container sidewalls. For example, as described in further detail herein, an exemplary liner 100 may undergo one or more manufacturing operations such that the liner 100 may define at least a portion of an exemplary container. In various embodiments, an exemplary liner 100 may embody one or more of an outer liner, an inner liner, and a flute, as described herein. As used herein, the terms “outer” and “inner” are used as descriptive terms for illustrative purposes in order to distinguish between various components of an exemplary container described herein. The terms “outer” and “inner” should not be interpreted for purposes of limitation, but rather for purposes of describing the spatial configuration of an exemplary container and/or components thereof relative to an internal container portion defined by the exemplary container.

As illustrated in FIG. 1A, in various embodiments, a liner 100 may comprise at least one coating layer applied to one or both of a first liner surface 110 and a second liner surface 120. In various embodiments, a coating layer may comprise a material applied to an area of a surface so as to adhere to the surface and at least partially cover (e.g., coat) the area of the surface to which the material is applied. As described herein, a coating layer adhered to a liner surface may be configured to provide a substantially moisture resistant barrier for the liner surface to which it is applied so as to prevent a volume of a fluid, such as, for example, water, from penetrating said liner surface. Further, in addition to providing an increased moisture-resistance, a coating layer applied to a liner surface of a container, as described herein, may be configured to increase one or more strength characteristics of the liner while also facilitating both the repulpability and the recyclability of the liner. In various embodiments, a coating layer may comprise an at least substantially water-resistant material. An exemplary coating layer as described herein may be configured to provide a moisture-resistant barrier to a liner to which the coating layer is applied while simultaneously providing structural support for the liner such that the liner may at least substantially maintain its structural integrity (e.g., crushing strength resistance) under an at least partially wet condition. As a non-limiting example, the coating layer may comprise a polymeric material, such as, for example, vinyl acetate, styrene acrylic, 2-Ethylhexyl acrylate (2-EHA), acrylic copolymer, styrene copolymer, vinyl copolymer, polyethylene (PE), polypropylene (PP), polyvinylidene chloride (PVDC), and/or the like. For example, an exemplary coating material may comprise a water-based polymer material made of at least approximately between 30%-60% solid material (e.g., between 40%-50% solid material). In various embodiments, as described herein, a coating layer may be adhered to a liner surface by various application processes such as, for example, air knife coating, rod coating, Greve printing, extrusion coating, extrusion lamination, lamination adhesion, and/or the like, using one or more apparatuses, such as, for example, a roll coating machine, a rotary lamination press, a spray applicator, and/or the like. In various embodiments, a liner 100 may comprise a first coating layer 411 and a second coating layer 412 configured directly adjacent the first liner surface 110 and the second liner surface 120, respectively.

FIG. 1B illustrates a cross-sectional view of an exemplary flute 300 according to various embodiments described herein. In various embodiments, the flute 300 may comprise a sheet of material arranged within the container medium 130 of an exemplary container, as described herein, in a substantially corrugated configuration so as to define an alternating plurality of peaks and valleys (e.g., a substantially wave-shaped configuration). As described herein, in various embodiments, the flute 300 may comprise a semi-rigid sheet configured to facilitate the insulation properties of the exemplary container 10 and/or provide added strength (e.g., crushing force resistance) to one or more sidewalls of the container so as to increase the structural integrity of the container 10. As a non-limiting example, the flute may be made from a cellulose-based material such as, for example, wood pulp, cotton, straw, and/or the like. For example, the flute 300 may comprise cardboard, paperboard, fiberboard, containerboard, and/or the like. The flute 300 may be defined at least in part by a flute thickness. As described in further detail herein, the flute thickness may comprise a distance between a first flute surface and a second flute surface. In various embodiments, the flute thickness may be at least substantially uniform and/or at least substantially varied at various locations about the flute 300. As illustrated in FIG. 1B and described in further detail herein, in various embodiments, a flute 300 may comprise at least one coating layer applied to one or both of a first flute surface 310 and a second flute surface 320, such as, for example, a first flute coating layer 431 and a second flute coating layer 432 configured directly adjacent the first flute surface 310 and the second flute surface 320, respectively. As a non-limiting example, in various embodiments, the at least one coating layer may comprise one or more layers of hydrogenated triglyceride, paraffin wax, and/or the like.

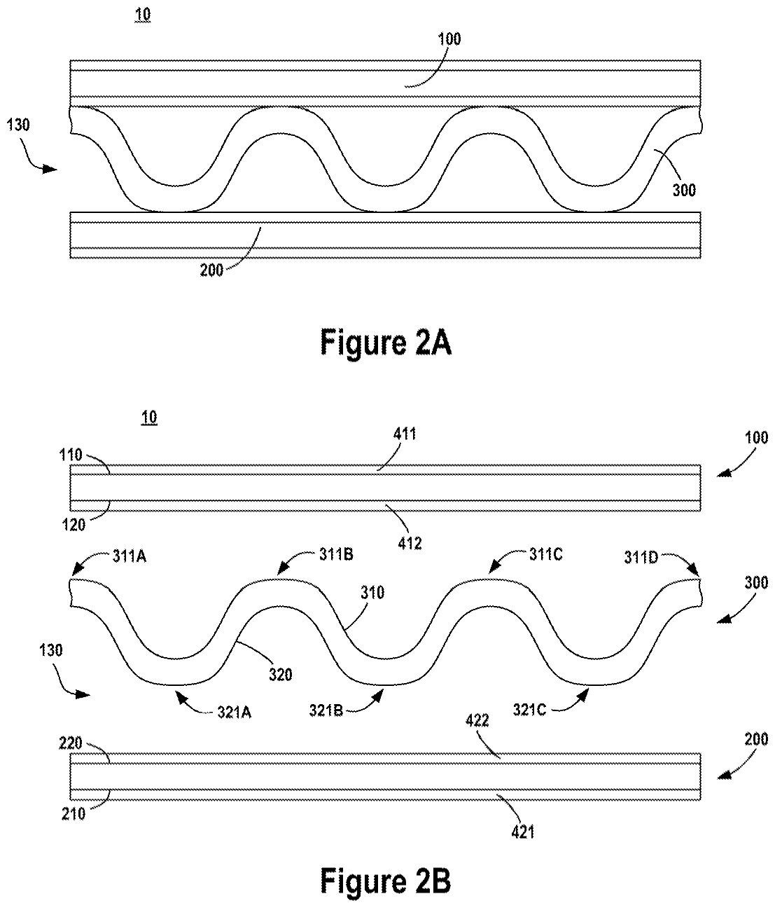

FIGS. 2A-2B illustrate cross-sectional exemplary views of an exemplary container according to various embodiments. In particular, FIG. 2A illustrates a cross-sectional view of an exemplary repulpable and recyclable container 10 comprising a substantially water-resistant configuration, as described herein. An exemplary container 10 may comprise an outer liner 100 and an inner liner 200. In various embodiments, at least a portion of each of the outer liner 100 and the inner liner 200 may comprise an at least substantially planar surface. As illustrated, the container 10 may be configured such that at least a portion of the outer liner 100 is at least substantially parallel to at least a portion of the inner liner 200. For example, the outer liner 100 and the inner liner 200 may be separated a distance extending therebetween, the distance extending therebetween defining at least a portion of the sidewall medium 130 comprising a volume of air positioned between the outer liner 100 and the inner liner 200, as described herein. In various embodiments, the sidewall medium 130 may further comprise a sidewall flute 300 arranged between the outer liner 100 and the inner liner 200, as described herein.

In various embodiments, an exemplary container 10 may comprise one or more sidewalls and may be configured such that at least a portion of each of the outer liner 100, inner liner 200, and flute 300 arranged therebetween may collectively define the one or more sidewalls of the container 10. In various embodiments, the container 10 be configured such that the one or more sidewalls of the container 10 collectively define an interior container portion configured to house one or more objects disposed therein. In such an exemplary circumstance, the container 10 may be configured such that portion of each of the one or more sidewalls defined by the inner liner 200 is arranged directly adjacent the interior container portion of the container 10. For example, the inner liner 200 of the container 10 may define at least a portion of the outer boundary of the interior container portion. In such an exemplary circumstance, the outer liner 100 may define the external surface of the container 10 such that the outer liner 100 is configured to interface an ambient environment. As a non-limiting example, the container 10 may comprise a corrugated cardboard box.

In various embodiments, the outer liner 100 may be defined at least in part by an outer liner thickness. For example, as described in further detail herein, the outer liner thickness may comprise a distance between a first outer liner surface and a second outer liner surface. In various embodiments, the outer liner thickness may be at least substantially uniform and/or at least substantially varied at various locations about the outer liner 100.Further, in various embodiments, the inner liner 200 of exemplary container 10 may be defined at least in part by an inner liner thickness. For example, as described in further detail herein, the inner liner thickness may comprise a distance between a first inner liner surface and a second inner liner surface. In various embodiments, the inner liner thickness may be at least substantially uniform and/or at least substantially varied at various locations about the inner liner 200.

In various embodiments, the container 10 may be configured so as to define a sidewall medium 130 a space extending between the outer liner 100 and the inner liner 200. For example, in various embodiments, the container medium 130 may comprise a volume of air arranged within at least a portion of the container medium 130. Further, in various embodiments, the container medium 130 may comprise a flute 300.

FIG. 2B illustrates an exploded cross-sectional view of an exemplary repulpable and recyclable container 10 according to various embodiments. As illustrated in FIG. 2B, the outer liner 100 may comprise a first outer liner surface 110 and a second outer liner surface 120. As described herein, the outer liner 100 may be defined at least in part by an outer liner thickness, which may be defined as a perpendicular distance between the first outer liner surface 110 and the second outer liner surface 120. For example, in various embodiments, the outer liner thickness may be at least approximately between 0.01 inches and 0.2 inches (e.g., between 0.03 inches and 0.1 inches). As illustrated, in various embodiments, the outer liner 100 may be configured such that first outer liner surface 110 is arranged to face an outward-facing direction away from the interior container portion of the container 10. For example, in various embodiments, the first outer liner surface 110 may interface the ambient environment so as to define at least a portion of the exterior of the exemplary container 10. Further, in various embodiments, the outer liner 100 may be configured such that the second outer liner surface 120 is arranged to face a direction away from the first outer liner surface 110, such as, for example, an inward-facing direction towards the inner liner 200 of the container 10. For example, the second outer liner surface 120 may interface at least a portion of a sidewall medium 130. In such an exemplary circumstance, the second outer liner surface 120 may interface at least a portion of the flute 300, as described herein.

In various embodiments, the outer liner 100 may comprise at least one coating layer applied to one or both of the first outer liner surface 110 and the second outer liner surface 120. In various embodiments, a coating layer may comprise a material applied to an area of a surface so as to adhere to the surface and at least partially cover (e.g., coat) the area of the surface to which the material is applied, as described herein. The one or more coating layer may function to increase one or more strength characteristics of the liner, such that the structural integrity of the liner may be maintained in an exemplary circumstance wherein a volume moisture has penetrated a liner surface and absorbed by the liner material. In various embodiments, the outer liner 100 may comprise at least two coating layers. As illustrated in FIG. 2B, the at least one coating layer of the outer liner 100 may comprise a first outer coating layer 411 and a second outer coating layer 412 configured directly adjacent the first outer liner surface 110 and the second outer liner surface 120, respectively. For example, in various embodiments, the first outer coating layer 411 may be adhered to the first outer liner surface 110 such that the first outer coating layer is arranged about an exterior of the exemplary container 10 adjacent an ambient environment. In various embodiments, the first outer coating layer 411 may be defined at least in part by a first outer coating layer thickness, defined as the thickness of the first outer coating layer 411 measured from the first outer liner surface 110 in an outward perpendicular direction. For example, in various embodiments, the first outer coating layer thickness may be at least approximately between 0.1 inches and 0.2 inches (e.g., between 0.3 inches and 0.1 inches). Further, in various embodiments, for example, the ratio of the first outer coating layer thickness to the outer liner thickness may be at least approximately between 1:20 and 1:1 (e.g., between 1:15 and 1:3).

As a further example, in various embodiments, the second outer coating layer 412 may be adhered to the second outer liner surface 120 such that the second outer coating layer 412 is arranged adjacent at least a portion of a sidewall medium 130. In such an exemplary circumstance, the second outer coating layer 412 may interface at least a portion of the flute 300 and/or a volume of bonding agent applied thereto, as described herein. In various embodiments, the second outer coating layer 412 may be defined at least in part by a second outer coating layer thickness, defined as the thickness of the second outer coating layer 412 measured from the second outer liner surface 120 in an inward perpendicular direction (e.g., toward the container medium 130). For example, in various embodiments, the second outer coating layer thickness may be at least approximately between 0.1 inches and 0.2 inches (e.g., between 0.3 inches and 0.1 inches). Further, in various embodiments, for example, the ratio of the second outer coating layer thickness to the outer liner thickness may be at least approximately between 1:20 and 1:1 (e.g., between 1:15 and 1:3).

As illustrated in FIG. 2B, the inner liner 200 of the exemplary container 10 may comprise a first inner liner surface 210 and a second inner liner surface 220. As described herein, the inner liner 200 may be defined at least in part by an inner liner thickness, which may be defined as a perpendicular distance between the first inner liner surface 210 and the second inner liner surface 220. For example, in various embodiments, the inner liner thickness may be at least approximately between 0.1 inches and 0.2 inches (e.g., between 0.3 inches and 0.1 inches). As illustrated, in various embodiments, the inner liner 200 may be configured such that first inner liner surface 210 is arranged to face an inward-facing direction toward an interior container portion of the container 10. For example, the inner liner 200 may be configured such that first inner liner surface 210 is arranged to face a direction away from a corresponding portion of the outer liner 100. In various embodiments, the first inner liner surface 210 may interface the interior container portion of the container 10 so as to define at least a portion of the outer boundary of the interior container portion. Further, in various embodiments, the inner liner 200 may be configured such that the second inner liner surface 220 is arranged to face a direction away from the first inner liner surface 210, such as, for example, an outward-facing direction away from the interior container portion of the container 10 (e.g., towards a corresponding portion of the outer liner 100). For example, the second inner liner surface 220 may interface at least a portion of the sidewall medium 130. In such an exemplary circumstance, the second inner liner surface 220 may interface at least a portion of the flute 300, as described herein.

In various embodiments, the inner liner 200 may comprise at least one coating layer applied to one or both of the first inner liner surface 210 and the second inner liner surface 220. For example, in various embodiments, the inner liner 200 may comprise at least two coating layers. As illustrated in FIG. 2B, the at least one coating layer of the inner liner 200 may comprise a first inner coating layer 421 and a second inner coating layer 422 configured directly adjacent the first inner liner surface 210 and the second outer liner surface 220, respectively. For example, in various embodiments, the first inner coating layer 421 may be adhered to the first inner liner surface 210 such that the first inner coating layer 421 is arranged adjacent the internal container portion of the container 10. In various embodiments, the first inner coating layer 421 may be defined at least in part by a first inner coating layer thickness, defined as the thickness of the first inner coating layer 411 measured from the first inner liner surface 210 in an inward perpendicular direction. For example, in various embodiments, the first inner coating layer thickness may be at least approximately between 0.1 inches and 0.2 inches (e.g., between 0.3 inches and 0.1 inches). Further, in various embodiments, for example, the ratio of the first inner coating layer thickness to the inner liner thickness may be at least approximately between 1:20 and 1:1 (e.g., between 1:15 and 1:3).

As a further example, in various embodiments, the second inner coating layer 422 may be adhered to the second inner liner surface 220 such that the second inner coating layer 422 is arranged adjacent at least a portion of a sidewall medium 130. In such an exemplary circumstance, the second inner coating layer 422 may interface at least a portion of the flute 300 and/or a volume of bonding agent applied thereto, as described herein. In various embodiments, the second inner coating layer 422 may be defined at least in part by a second inner coating layer thickness, defined as the thickness of the second inner coating layer 422 measured from the second inner liner surface 220 in an outward perpendicular direction (e.g., toward the container medium 130). For example, in various embodiments, the second inner coating layer thickness may be at least approximately between 0.1 inches and 0.2 inches (e.g., between 0.3 inches and 0.1 inches). Further, in various embodiments, for example, the ratio of the second inner coating layer thickness to the inner liner thickness may be at least approximately between 1:20 and 1:1 (e.g., between 1:15 and 1:3).

As illustrated in FIG. 2B, the flute 300 of the exemplary container 10 may be arranged in between the second outer liner surface 120 of the outer liner 100 and second inner liner surface 220 of the inner liner 200 so as to define at least a portion of the sidewall medium 130. In various embodiments, the flute 300 may comprise an outer flute surface 310 and an inner flute surface 320. As described herein, the flute 300 may be defined at least in part by a flute thickness, which may be defined as a perpendicular distance between the outer flute surface 310 and the inner flute surface 320. For example, in various embodiments, the flute thickness may be at least approximately between 0.1 inches and 0.2 inches (e.g., between 0.3 inches and 0.1 inches). As illustrated, in various embodiments, the flute 300 may be configured such that the outer flute surface 310 is arranged to face an outward-facing direction away from the interior container portion of the container 10 and toward the outer liner 100. Further, in various embodiments, the flute 300 may be configured such that the inner flute surface 320 is arranged to face an inward-facing direction toward both the interior container portion of the container 10 and the inner liner 200.

In various embodiments, the flute 300 may comprise one or more plurality of contact portions defined by the wave-shaped configuration (e.g., at least a portion of the peaks formed by the corrugated profile) of the flute 300 and configured to physically engage a corresponding interface portion of an adjacent liner surface. An exemplary container 10 may be configured such that at least a portion of the outer flute surface 310 may interface at least a portion of the second outer liner surface 120 of the outer liner 100, described herein as outer liner interface portions. For example, as illustrated, the outer flute surface 310 may comprise a plurality of outer flute surface contact portions 311A, 311B, 311C, 311D configured to engage a corresponding plurality of outer liner interface portions positioned directly adjacent thereto. Further, in various embodiments, at least a portion of the inner flute surface 320 may interface at least a portion of the second inner liner surface 220 of the inner liner 200, described herein as inner liner interface portions. For example, as illustrated, the inner flute surface 320 may further comprise a plurality of inner flute surface contact portions 321A, 321B, 321C configured to engage a corresponding plurality of inner liner interface portions positioned directly adjacent thereto. In various embodiments wherein one or both of the outer liner 100 and the inner liner 200 comprise a coating layer (e.g., a second outer coating layer 412 applied to the second outer liner surface 120 and/or a second inner coating layer 422 applied to the second inner liner surface 220), as described herein, it should be understood that the plurality of outer flute surface contact portions 311A, 311B, 311C, 311D and/or plurality of inner flute surface contact portions 321A, 321B, 321C may be configured to engage a corresponding coating layer positioned adjacent thereto.

In various embodiments, the flute 300 may comprise at least one coating layer applied to one or both of the outer flute surface 310 and the inner liner surface 320. As described herein, a coating layer adhered to a flute surface may be configured to provide a substantially moisture resistant barrier for the flute surface to which it is applied so as to prevent a volume of a fluid, such as, for example, water, from penetrating said flute surface. Further, in addition to providing an increased moisture-resistance, a coating layer applied to a fluid surface of a container, as described herein, may be configured to facilitate both the repulpability and the recyclability of the container.

In various embodiments, the flute 300 may comprise at least two coating layers. In various embodiments, the at least one coating layer of the flute 300 may comprise an outer flute coating layer 431 and an inner flute coating layer 432 configured directly adjacent the outer flute surface 310 and the inner flute surface 320, respectively. For example, in various embodiments, an outer flute coating layer 431 may be adhered to the outer flute surface 310 such that the outer flute coating layer 431 is arranged adjacent at least a portion of a sidewall medium 130. In various embodiments, the outer flute coating layer 431 may be defined at least in part by an outer flute coating layer thickness, defined as the thickness of the outer flute coating layer 431 measured from the outer flute surface 310 in an outward perpendicular direction (e.g., away from the internal container portion). For example, in various embodiments, an outer flute coating layer thickness may be at least approximately between 0.1 inches and 0.2 inches (e.g., between 0.3 inches and 0.1 inches). Further, in various embodiments, for example, a ratio of the outer flute coating layer thickness to the flute thickness may be at least approximately between 1:20 and 1:1 (e.g., between 1:15 and 1:3).

As a further example, in various embodiments, an inner flute coating layer 432 may be adhered to the inner flute surface 320 such that the inner flute coating layer 432 is arranged adjacent at least a portion of a sidewall medium 130. In various embodiments, the inner flute coating layer 432 may be defined at least in part by an inner flute coating layer thickness, defined as the thickness of the inner flute coating layer 432 measured from the inner flute surface 320 in an inward perpendicular direction (e.g., toward the internal container portion). For example, in various embodiments, an inner flute coating layer thickness may be at least approximately between 0.1 inches and 0.2 inches (e.g., between 0.03 inches and 0.1 inches). Further, in various embodiments, for example, a ratio of the inner flute coating layer thickness to the flute thickness may be at least approximately between 1:20 and 1:1 (e.g., between 1:15 and 1:3).

In various embodiments, an exemplary container described herein comprising at least one coating layer applied to one or more surfaces of a liner (e.g., an outer liner and/or an inner liner) and/or a sidewall flute (e.g., an outer flute surface and/or an inner flute surface) may represent a substantial reduction of coating material relative to traditional containers known in the art (e.g., containers comprising a paraffin wax coating applied via a cascade application method), which may result in a container weight reduction that enables a repulpable and recyclable container configuration without compromising the strength or integrity of the container. For example, in various embodiments, an exemplary container comprising one or more coated liners (e.g., an outer liner, an inner liner, and/or a sidewall flute) may be configured to withstand a crushing force of at least substantially 1500 lbf (between 1500 lbf and 1800 lbf) when the liners have not been compromised by moisture. By way of further example, an exemplary container comprising one or more coated liners (e.g., an outer liner, an inner liner, and/or a sidewall flute) may be configured to withstand a crushing force of at least substantially between 600 lbf (between 600 lbf and 800 lbf) after having been soaked in water for at least approximately 60 minutes.

In various embodiments, an exemplary container 10 may be configured such that a liner may be bonded to the flute 300 using a bonding agent such as, for example, an adhesive. For example, an adhesive may be applied to at least a portion of the second outer liner surface 120 (e.g., the outer liner interface portions) such that in an exemplary circumstance wherein the flute 300 is arranged adjacent the outer liner 100, the bonding agent may contact at least a portion of the flute 300 (e.g., at least a portion of the plurality of outer flute contact portions 311A, 311B, 311C, 311D) in order to facilitate the bonding of the outer liner 100 to the flute 300. Additionally, or alternatively, an adhesive may be applied to at least a portion of the outer flute surface 310 (e.g., at least a portion of the plurality of outer flute contact portions 311A, 311B, 311C, 311D) such that in an exemplary circumstance wherein the flute is arranged adjacent the outer liner 100, the bonding agent may contact at least a portion of the second outer liner surface 120 (e.g., the outer liner interface portions) in order to facilitate the bonding of the flute 300 to the outer liner 100. As described herein, in various embodiments wherein the outer liner 100 comprises a second outer coating layer 412 applied to the second outer liner surface 120, as described herein, it should be understood that a bonding agent may be applied to at least a portion the second outer coating layer 412. In various embodiments, a bonding agent applied to at least a portion of the plurality of outer flute surface contact portions 311A, 311B, 311C, 311D may be configured to engage the second outer coating layer 412 to facilitate the bonding of the flute 300 to the outer liner 100.

Further, in various embodiments, an adhesive may be applied to at least a portion of the second inner liner surface 220 (e.g., the inner liner interface portions) such that in an exemplary circumstance wherein the flute 300 is arranged adjacent the inner liner 200, the bonding agent may contact at least a portion of the flute 300 (e.g., at least a portion of the plurality of inner flute contact portions 321A, 321B, 321C, 321D) in order to facilitate the bonding of the inner liner 200 to the flute 300. Additionally, or alternatively, an adhesive may be applied to at least a portion of the inner flute surface 320 (e.g., at least a portion of the plurality of inner flute contact portions 321A, 321B, 321C, 321D) such that in an exemplary circumstance wherein the flute is arranged adjacent the inner liner 200, the bonding agent may contact at least a portion of the second inner liner surface 220 (e.g., the inner liner interface portions) in order to facilitate the bonding of the flute 300 to the inner liner 200. As described herein, in various embodiments wherein the inner liner 200 comprises a second inner coating layer 422 applied to the second inner liner surface 220, as described herein, it should be understood that a bonding agent may be applied to at least a portion the second inner coating layer 422. In various embodiments, a bonding agent applied to at least a portion of the plurality of inner flute surface contact portions 321A, 321B, 321C, 321D may be configured to engage the second inner coating layer 422 to facilitate the bonding of the flute 300 to the inner liner 200.

As described herein, in various embodiments, the bonding agent may be configured to facilitate the adhesion of two adjacent surfaces of a container 10 such that a semi-permanent bond may be formed therebetween. Accordingly, the bonding agent may be configured to facilitate the bonding of at least two components, one or more of which may comprise a coating layer. For example, the bonding agent may be configured to bond any combination of surfaces of the exemplary container 10 described herein, such as, for example, a non-coated surface (e.g., a cellulose-based material) and a non-coated surface, a non-coated surface and a coated surface (e.g., a water-resistant polymeric material), and a coated surface and a coated surface. In various embodiments, the bonding agent may comprise a starch-based adhesive comprising one or more additive agents configured to facilitate the bonding between adjacent coated and/or uncoated surfaces of an exemplary container. For example, in various embodiments, the one or more additive agents may comprise a solution and/or an emulsion polymer that is compatible with a starch adhesive formula having a high pH value. As non-limiting examples provided for illustrative purposes, various exemplary monomers, such as, for example, styrene, acrylics, vinyl acetate, styrene butadiene, copolymer blends of the aforementioned monomers, and/or the like, may be used in a starch-based adhesive as described herein. Alternatively, in various embodiments, the bonding agent may comprise a non-starch-based adhesive configured to facilitate the bonding between adjacent coated and/or uncoated surfaces of an exemplary container.

### Exemplary Manufacturing Apparatus

Various embodiments described herein are directed to a system for manufacturing a container according to various embodiments described herein. In various embodiments, the container manufacturing system described herein may be configured to apply a coating layer, as described herein, to both planar surfaces of an exemplary liner. For example, the exemplary container manufacturing system may be configured to facilitate the manufacture of an exemplary container comprising an outer liner and an inner liner, wherein one or both of the outer liner and the inner liner comprise a coating layer applied to both a first surface and a second surface thereof. As described herein, in various embodiments, an exemplary container manufacturing system may be configured to manufacture, at least in part, an exemplary container comprising a plurality of liners, each of the liners having a first coating layer applied to a first liner surface thereof and a second coating layer applied to a second coating surface thereof. The container manufacturing system described herein may be configured to facilitate the application of one or more coating layers to at least one surface of a liner. For example, in various embodiments, the container manufacturing system may be configured to apply a coating layer, as described herein, to at least one surface of a liner using one or more application techniques, such as, for example, extrusion coating, extrusion lamination, lamination adhesion, and/or the like, using one or more apparatuses, such as, for example, an exemplary container production assembly defined at least in part by a roll coating machine, a rotary lamination press, a spray applicator, and/or the like. Although described herein as being configured to apply a coating layer to one or more surfaces of an exemplary liner, it should be understood that an exemplary container production assembly may be similarly configured to apply one or more coating layers to one or more surfaces of an exemplary flute, as described herein. Further, it should be understood that a liner to which an exemplary apparatus has applied one or more coating layers may be subsequently processed by a container manufacturing system such that the coated liner embodies a flute within an exemplary container.

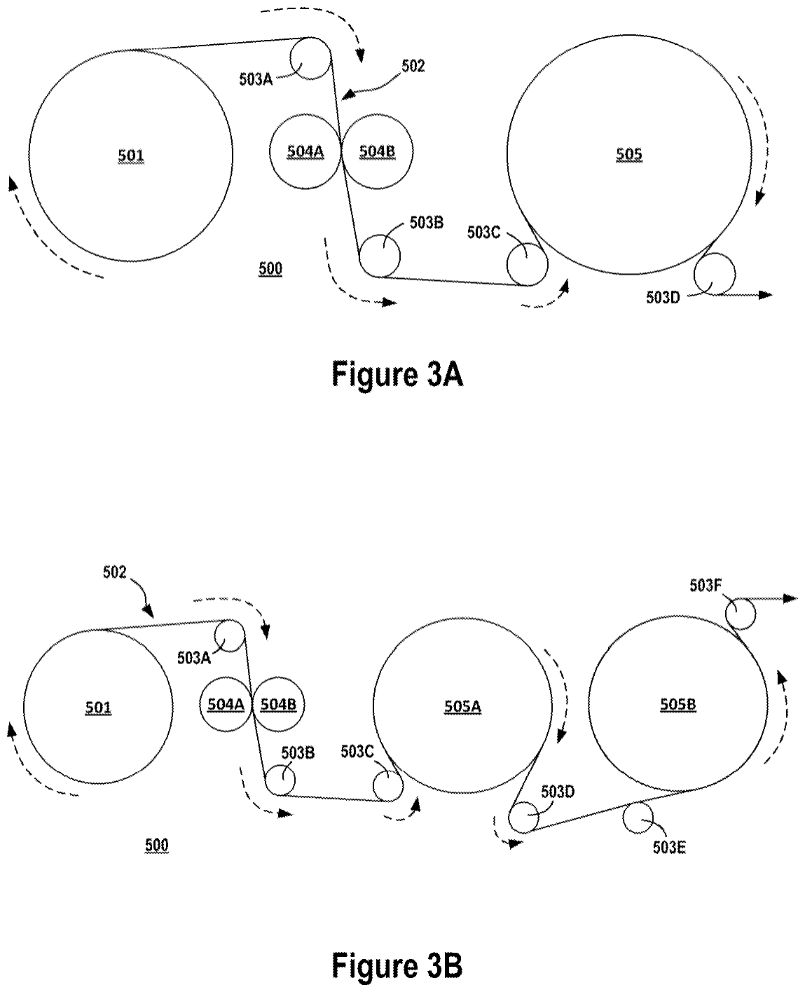

FIGS. 3A-3B are schematic illustrations of exemplary container production assemblies according to various embodiments. In particular, FIGS. 3A-3B schematically illustrate various exemplary container manufacturing systems comprising one or more container production assembly configured to facilitate the manufacture of an exemplary container according to various embodiments described herein. As an illustrative example, FIG. 3A schematically illustrates an exemplary container production assembly 500 configured to facilitate the manufacture of an exemplary container according to various embodiments described herein. In various embodiments, the exemplary assembly 500 may be configured to apply a coating layer, as described herein, to both planar surfaces of an exemplary liner. For example, the illustrated exemplary assembly 500 may be configured to facilitate the manufacture of an exemplary container comprising an outer liner and an inner liner, wherein one or both of the outer liner and the inner liner comprise a coating layer applied to both a first surface and a second surface thereof. As illustrated, the illustrated exemplary assembly 500 may be configured to process a liner by utilizing one or more rollers, as described herein, to facilitate the movement of the liner in a feed direction along a liner feed path. The exemplary assembly 500 may be configured such that as the liner travels along the liner feed path, one or more components of the exemplary assembly 500 may engage at least a portion of the liner so as to apply a coating layer thereto.

As illustrated, an exemplary assembly 500 may comprise a liner supply 501. In various embodiments, the liner supply 501 may comprise an assembly component configured to store one or more uncoated liners and/or facilitate the feed of the stored uncoated liner(s) in a feed direction towards one or more downstream components of the exemplary assembly 500 along a liner feed path. As non-limiting examples, in various embodiments, the liner supply 501 may comprise a stacked plurality of uncoated liners or a roll containing a plurality of uncoated liners in a wound configuration about a spool. For example, a liner feed 502 comprising at least a portion of one or more exemplary liners may originate from the liner supply 501 and extend along a liner feed path towards one or more downstream components of the exemplary assembly 500 (e.g., a plurality of coating rollers 504A, 504B). In various embodiments, the exemplary assembly 500 may be configured to accommodate a liner feed 502 comprising a continuous plurality of liners configured to travel along the liner feed path and be processed by the exemplary assembly 500 in sequence.

As described herein, the exemplary assembly 500 may comprise one or more guide rollers configured to facilitate the movement of the one or more liners along the liner feed path in the feed direction. The configuration of the guide rollers may define at least a portion of the liner feed path. For example, as illustrated in FIG. 3A, the one or more guide rollers may comprise a plurality of guide rollers 503A, 503B, 503C, 503D configured to direct the liner feed 502 in a feed direction (e.g., downstream) along the liner feed path throughout the assembly 500. In various embodiments, the one or more guide rollers 503A, 503B, 503C, 503D may be configured as passive rollers such that the roller may freely rotate about an axis in response to one or more forces applied thereto, such as, for example, a frictional force transmitted from a portion of the liner feed 502 that may engage the roller as it travels along a liner feed path. Alternatively, or additionally, in various embodiments, at least a portion of the guide rollers 503A, 503B, 503C, 503D may be configured as driven rollers such that the roller may be driven (i.e. powered) to facilitate the motion of the liner feed 502 in contact therewith along the liner feed path at a desired feed rate.

As described herein, in various embodiments, the exemplary assembly 500 may be configured to apply at least one coating layer to at least a portion of a liner (e.g., the liner feed 502) traveling along the liner feed path. In various embodiments, the exemplary assembly 500 may comprise one or more coating rollers 504A, 504B configured to apply a coating layer to at least one surface of the liner feed 502. For example, in an exemplary circumstance wherein the one or more coating rollers comprises a plurality of rollers 504A, 504B, as illustrated in FIGS. 3A-3B, each coating roller of the plurality of coating rollers 504A, 504B may be configured to apply a coating layer to a respective surface of the liner feed 502 engaged therewith. In various embodiments, a coating roller may be configured such that a volume of coating material, such as, for example, a polymeric material including vinyl acetate, styrene acrylic, 2-Ethylhexyl acrylate (2-EHA), acrylic copolymer, styrene copolymer, vinyl copolymer, and/or the like, present on the surface of the coating roller may be transmitted to at least a portion of the liner feed 502 engaged therewith as the liner feed 502 travels along the liner feed path. For example, the exemplary assembly 500 may be configured to constantly supply a volume of coating material to the surface of each coating roller 504A, 504B such that the volume of coating material may be continuously transmitted from each coating roller 504A, 504B to the respective surfaces of a continuous liner feed 502 engaged therewith as the liner feed 502 travels along the liner feed path. For example, in various embodiments, each coating roller 504A, 504B of the exemplary assembly 500 may comprise a means of maintaining a volume of coating material at the respective surface thereof. As non-limiting examples, each coating roller 504A, 504B may include a stationary pool of coating material, a coating material spray or drip applicator, and/or the like configured to continuously apply a volume of coating material to the surface of the respective coating roller as the coating roller rotates relative thereto about its axis. In various embodiments, the exemplary assembly 500 may comprise one or more means for controlling the amount of coating material applied to a surface, such as, for example, one or more nip rollers.

In various embodiments, the one or more coating rollers 504A, 504B may be configured as passive rollers such that the roller may freely rotate about an axis in response to one or more forces applied thereto, such as, for example, a frictional force transmitted from a portion of the liner feed 502 that may engage the roller as it travels along a liner feed path. Alternatively, or additionally, in various embodiments, at least a portion of the coating rollers 504A, 504B may be configured as driven rollers such that the roller may be driven (i.e. powered) to facilitate the motion of the liner feed 502 in contact therewith along the liner feed path at a desired feed rate. In various embodiments the one or more coating rollers 504A, 504B may comprise one, two, three, four, five, six, ten, fifteen, and/or twenty coating rollers, or any number of coating rollers that may be incorporated into the exemplary assembly 500 to facilitate the liner coating functionality described herein. Although illustrated as comprising coating rollers 504A, 504B configured to apply respective coating layers to a liner, an exemplary assembly 500 may comprise one or more additional and/or alternative components configured execute one or more processes, such as, by way of non-limiting examples, blade coating, air knife coating, rod coating, and/or the like, to apply a coating layer to the liner.

In various embodiments, an exemplary assembly 500 may comprise one or more dryers configured to interact with at least a portion of a liner traveling along the liner feed path so as to dry and cure the coating material applied to the liner, as described herein. In various embodiments, a dryer may be configured to cure one or more volumes of coating material applied to one or more surfaces of a liner. For example, as described herein, in an exemplary circumstance wherein a volume of coating material is applied to both a first surface of an exemplary liner and a second surface of an exemplary liner, the dryer may be configured to cure the respective volumes of coating material on the first liner surface and the second liner surface such that a coating layer may be adhered to each surface. In various embodiments, an exemplary dryer may embody a drying unit such as, for example, a heated roller, a heated platen, a hood dryer, or any other means configured to dry and cure a volume of coating material applied to the liner so as to form a coating layer adhered to at least one surface of the liner by, for example, a heat, infrared, and/or similar curing process.

The one or more dryers of an exemplary assembly 500 may be arranged in a downstream position along the liner feed path relative to the one or more coating rollers of the assembly 500, as described herein. As illustrated in FIG. 3A, the exemplary assembly 500 may comprise a dryer 505 arranged along the liner feed path of the liner feed 502 in a downstream position relative to the coating rollers 504A, 504B. In various embodiments, the one or more dryer may comprise a plurality of dryers, such as, for example, two, three, four, five, eight, ten, and/or fifteen dryers, or any number of dryers capable of facilitating the execution of the various drying operations described herein. For example, as illustrated in FIG. 3B, the exemplary assembly 500 may comprise a plurality of dryers 505A, 505B. For example, first dryer 505A may be configured to dry a volume of coating material applied to a first surface of a liner feed 502 and a second dryer 505B may be configured to dry a volume of coating material applied to a second surface of the liner feed 502. In such an exemplary circumstance, the exemplary assembly 500 may be configured such that the first dryer 505A and the second dryer 505B are respectively engaged with opposite sides of the liner feed 502 so as to produce an exemplary liner comprising a coating layer on each of the opposite surfaces (e.g., a top liner surface and a bottom liner surface) thereof. In various embodiments, dryer 505 may be configured to operate at least approximately between 100° C. and 200° C. (e.g., between 150° C. and 185° C.). For example, in various embodiments, en exemplary apparatus 500 may be configured such that a surface of a liner (e.g., a surface of the liner feed 502) travelling along a liner feed path may be exposed to and/or engaged with a dryer 505 for at least approximately between 5 minutes and 60 minutes (e.g., between 15 minutes and 30 minutes).

In various embodiments, an exemplary assembly 500 may further comprise at least one means of applying a volume of adhesive to at least a portion of a liners, such as for example, one or more adhesive applicators configured to interact with at least a portion of a liner traveling along the liner feed path so as to selectively apply an adhesive to the liner, as described herein. In various embodiments, an adhesive application means of an exemplary assembly 500 may be configured to apply a volume of adhesive to one or more coating layers adhered to a respective surface of a liner. The at least one adhesive application means of an exemplary assembly 500 may be arranged in a downstream position along the liner feed path relative to the one or more dryers 505 of the assembly 500, as described herein.

As described herein, an exemplary assembly 500 may define at least a portion of an exemplary container manufacturing system. In various embodiments, an exemplary container manufacturing system may comprise a corrugator apparatus configured to at least partially assemble an exemplary container using one or more liners, as described herein. For example, in various embodiments, the exemplary assembly 500 may be positioned in-line with a corrugator apparatus in an exemplary manufacturing setting. In such an exemplary circumstance, an apparatus 500 configured to apply at least one coating layer to a liner may be arranged upstream from the corrugator apparatus such that an exemplary container assembled by the corrugator apparatus is defined at least in part by a liner comprising at least one coating layer. For example, an exemplary container manufacturing system may be configured such that an exemplary container assembled by the corrugator apparatus is defined at least in part by a liner comprising a plurality of coating layers respectively adhered to both opposite surfaces of the liner. Alternatively, or additionally, the assembly 500 may define a portion of a corrugator apparatus such that the liner feed path of the assembly 500 defines a portion of a liner feed path of the corrugator apparatus.

### Exemplary Method of Manufacture

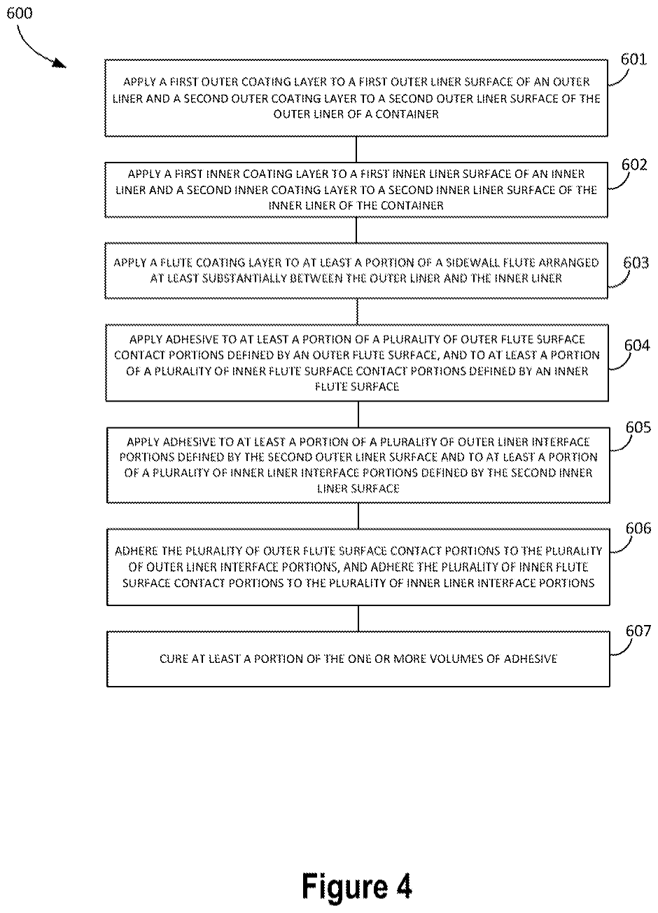

Various embodiments described herein are directed to a method of manufacturing a repulpable and recyclable container. For example, FIG. 4 is a flowchart illustrating example steps for manufacturing a repulpable and recyclable container in accordance with various embodiments described herein. As shown in FIG. 4, a repulpable and recyclable container may be manufactured by producing a container including at least one liner comprising one or more surfaces having a coating layer applied thereto. The exemplary method 600 begins at Block 601, with applying a first outer coating layer to a first outer liner surface of an outer liner and a second outer coating layer to a second outer liner surface of the outer liner of a container. For example, a first outer coating material may be applied to a first outer liner surface such that the first outer coating layer thickness may be at least approximately between 0.01 inches and 0.2 inches (e.g., between 0.03 inches and 0.1 inches). That is, a coating material may be applied to the first outer liner surface such that the first outer coating layer thickness may be at least approximately between 0.1 pounds per million board feet (lbs/MBF) and 5 lbs/MBF (e.g., between 0.5 lbs/MBF and 2 lbs/MBF). In various embodiments, a volume of coating material may be applied to a first outer liner surface such that the first outer coating layer at least substantially covers at least a portion (e.g., an entirety) of the first outer liner surface to which it is adhered. Further, in various embodiments, a second outer coating material may be applied to a second outer liner surface such that the second outer coating layer thickness may be at least approximately between 0.01 inches and 0.2 inches (e.g., between 0.03 inches and 0.1 inches). That is, coating material may be applied to the second outer liner surface such that the second outer coating layer thickness may be at least approximately between 0.1 lbs/MBF and 5 lbs/MBF (e.g., between 0.5 lbs/MBF and 2 lbs/MBF). In various embodiments, a volume of coating material may be applied to a second outer liner surface such that the second outer coating layer at least substantially covers at least a portion (e.g., an entirety) of the second outer liner surface to which it is adhered. In various embodiments, applying a first outer coating layer and a second outer coating layer to an outer liner may comprise applying a volume of coating material to each of the first outer liner surface and the second outer liner surface and curing the applied coating material so as to produce a coating layer adhered to the portions of the first outer liner surface and the second outer liner surface at which the volumes of coating material were applied, as described herein.

At Block 602, a first inner coating layer may be applied to a first inner liner surface of an inner liner and a second inner coating layer may be applied to a second inner liner surface of the inner liner of the container. For example, a first inner coating material may be applied to a first inner liner surface such that the first inner coating layer thickness may be at least approximately between 0.01 inches and 0.2 inches (e.g., between 0.03 inches and 0.1 inches). That is, coating material may be applied to the first inner liner surface such that the first inner coating layer thickness may be at least approximately between 0.1 lbs/MBF and 5 lbs/MBF (e.g., between 0.5 lbs/MBF and 2 lb s/MBF). In various embodiments, a volume of coating material may be applied to a first inner liner surface such that the first inner coating layer at least substantially covers at least a portion (e.g., an entirety) of the first inner liner surface to which it is adhered. Further, in various embodiments, a second outer coating material may be applied to a second inner liner surface such that the second inner coating layer thickness may be at least approximately between 0.01 inches and 0.2 inches (e.g., between 0.03 inches and 0.1 inches). That is, coating material may be applied to the second inner liner surface such that the second inner coating layer thickness may be at least approximately between 0.1 lbs/MBF) and 5 lbs/MBF (e.g., between 0.5 lbs/MBF and 2 lbs/MBF). In various embodiments, a volume of coating material may be applied to a second inner liner surface such that the second inner coating layer at least substantially covers at least a portion (e.g., an entirety) of the second inner liner surface to which it is adhered. In various embodiments, applying a first inner coating layer and a second inner coating layer to an inner liner may comprise applying a volume of coating material to each of the first inner liner surface and the second inner liner surface and curing the applied coating material so as to produce a coating layer adhered to the portions of the first inner liner surface and the second inner liner surface at which the volumes of coating material were applied, as described herein.

At Block 603, a flute coating layer may be applied to a sidewall flute configured to define at least a portion of a container medium arranged between the outer liner and the inner liner of the container. As described herein, an exemplary sidewall flute may comprise an outer flute surface and an inner flute surface. In various embodiments, a flute coating layer may be applied to at least a portion of one or both of an outer flute surface and an inner flute surface. For example, an outer flute coating layer be applied to an outer flute surface such that the outer flute coating layer thickness may be at least approximately between 0.01 inches and 0.2 inches (e.g., between 0.03 inches and 0.1 inches). That is, coating material may be applied to the outer flute surface such that the outer flute coating layer thickness may be at least approximately between 0.1 lbs/MBF and 5 lbs/MBF (e.g., between 0.5 lbs/MBF and 2 lbs/MBF). In various embodiments, a volume of coating material may be applied to an outer flute surface such that the outer flute coating layer at least substantially covers at least a portion (e.g., an entirety) of the outer flute surface to which it is adhered. Further, in various embodiments, an inner flute coating layer be applied to an inner flute surface such that the inner flute coating layer thickness may be at least approximately between 0.01 inches and 0.2 inches (e.g., between 0.03 inches and 0.1 inches). That is, coating material may be applied to the inner flute surface such that the inner flute coating layer thickness may be at least approximately between 0.1 lbs/MBF) and 5 lbs/MBF (e.g., between 0.5 lbs/MBF and 2 lbs/MBF). In various embodiments, a volume of coating material may be applied to an inner flute surface such that the inner flute coating layer at least substantially covers at least a portion (e.g., an entirety) of the inner flute surface to which it is adhered. In various embodiments, applying a flute coating layer to one or more flute surfaces may comprise applying a volume of coating material to one or both of an outer flute surface and an inner flute surface and curing the applied coating material so as to produce a flute coating layer adhered to the portions of the outer flute surface and the inner flute surface at which the volumes of coating material were applied, as described herein.

At Block 604, a volume of adhesive may be applied to at least a portion of a plurality of outer flute surface contact portions defined by an outer flute surface, and a volume of adhesive may be applied to at least a portion of a plurality of inner flute surface contact portions defined by an inner flute surface. For example, as described herein, a volume of adhesive may be applied at one or more potions of an outer flute surface configured to at least substantially engage the second outer liner surface, such as, for example, an outer flute surface contact portion. Further, a volume of adhesive may be applied at one or more potions of an inner flute surface configured to at least substantially engage the second inner liner surface, such as, for example, an inner flute surface contact portion. In various embodiments, the exemplary step of applying a volume of adhesive to at least a portion of a plurality of outer flute surface contact portions defined by an outer flute surface, and applying a volume of adhesive to at least a portion of a plurality of inner flute surface contact portions defined by an inner flute surface, described herein in reference to Block 604, may be executed either in addition to, or in the alternative of, the exemplary step describe herein at Block 605.

At Block 605, a volume of adhesive may be applied to at least a portion of a plurality of outer liner interface portions defined by the second outer line surface, and a volume of adhesive may be applied to at least a portion of a plurality of inner liner interface portions defined by the second inner liner surface. For example, as described herein, a volume of adhesive may be applied at one or more potions of a second outer liner surface configured to at least substantially engage the outer flute surface, such as, for example, an outer liner interface portion. Further, a volume of adhesive may be applied at one or more potions of a second inner liner surface configured to at least substantially engage the inner flute surface, such as, for example, an inner liner interface portion. In various embodiments, the exemplary step of applying a volume of adhesive to at least a portion of a plurality of outer liner interface portions defined by the second outer line surface, and applying a volume of adhesive to at least a portion of a plurality of inner liner interface portions defined by the second inner liner surface, described herein in reference to Block 605, may be executed either in addition to, or in the alternative of, the exemplary step describe herein at Block 604.

At Block 606, the plurality of outer flute surface contact portions may be adhered to the plurality of outer liner interface portions, and the plurality of inner flute surface contact portions may be adhered to the plurality of inner liner interface portions. For example, the sidewall flute may be arranged proximate the outer liner and the inner liner such that at least a portion of the outer flute surface contact portions and the corresponding outer liner interface portions (e.g., and/or respective coating layers adhered thereto), as well as the inner flute surface contact portions and the corresponding inner liner interface portions (e.g., and/or respective coating layers adhered thereto) are physically engaged with respective volumes of adhesive.

At Block 607, the one or more volumes of adhesive may be at least substantially stabilized via one or more curing processes. For example, in various embodiments, the one or more volumes of adhesive applied to the second outer liner surface (e.g. the outer liner interface portions), the second inner liner surface (e.g., the inner liner interface portions), and/or the sidewall flute (e.g., the outer flute surface contact portions, the inner flute surface contact portions) may be cured via one or more curing processes. In various embodiments, an adhesive curing process described herein may comprising stabilizing (e.g., by a heating, infrared, ultraviolet, and/or similar process) one or more volumes of adhesive so as to stabilize a bond between two or more components of an exemplary container physically engaged with the adhesive.

In various embodiments, one or more of the operations described above with respect to exemplary method 600 may be executed by a container manufacturing system, as described herein.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A repulpable and recyclable container comprising:
an outer liner comprising a first outer liner surface and a second outer liner surface;
an inner liner comprising a first inner liner surface and a second inner liner surface;
a sidewall medium arranged between the second outer liner surface and the second inner liner surface, the sidewall medium being defined at least in part by a sidewall flute; and
one or more coating layers adhered to one or more of the first outer liner surface, the second outer liner surface, the first inner liner surface, and the second inner liner surface;
wherein the container is configured such that the flute is adhered to the outer liner and the inner liner via at least one volume of adhesive configured to directly engage at least a portion of the one or more coating layers.

2. The container of claim 1, wherein the one or more coating layers comprises a plurality of coating layers adhered to each of the first outer liner surface, the second outer liner surface, the first inner liner surface, and the second inner liner surface.

3. The container of claim 1, wherein at least a portion of the one or more coating layers is defined at least in part by a coating layer thickness of between 0.1 lbs/MBF and 5 lb s/MBF .

4. The container of claim 1, wherein at least a portion of the one or more coating layers is defined at least in part by a coating layer thickness, and wherein a ratio of the coating layer thickness to a liner thickness is at least approximately between 1:20 and 1:1.

5. The container of claim 1, further comprising one or more flute coating layers applied to at least a portion of the sidewall flute.

6. The container of claim 1, wherein the at least one volume of adhesive is further configured to directly engage at least a portion of the one or more flute coating layers.

7. The container of claim 1, wherein the at least one volume of adhesive comprises a non-starch-based adhesive.

8. The container of claim 1, wherein at least a portion of the one or more coating layers comprises a polymeric material.

9. A container manufacturing system configured to produce a repulpable and recyclable container, the system comprising:
a container production assembly configured to produce a repulpable and recyclable container comprising:
an outer liner comprising a first outer liner surface and a second outer liner surface;
an inner liner comprising a first inner liner surface and a second inner liner surface;
a sidewall medium arranged between the second outer liner surface and the second inner liner surface, the sidewall medium being defined at least in part by a sidewall flute; and
one or more coating layers adhered to one or more of the first outer liner surface, the second outer liner surface, the first inner liner surface, and the second inner liner surface;
wherein the container is configured such that the flute is adhered to the outer liner and the inner liner via at least one volume of adhesive configured to directly engage at least a portion of the one or more coating layers.

10. A method of manufacturing a repulpable and recyclable container, the method comprising:
applying a first outer coating layer to a first outer liner surface and a second outer coating layer to a second outer liner surface;
applying a first inner coating layer to a first inner liner surface and a second inner coating layer to a second inner liner surface;
applying at least one volume of adhesive to one or more of the second outer liner surface, the second inner liner surface and the sidewall flute; and
curing at least a portion of the at least one volumes of adhesive so as to secure at least a portion of the sidewall flute relative to the second outer liner surface and the second inner liner surface.

11. The method of claim 10, further comprising applying a flute coating layer to at least a portion of a sidewall flute configured to be arranged at least substantially between the second outer liner surface and the second inner liner surface.

12. The method of claim 10, wherein applying at least one volume of adhesive to one or more of the second outer liner surface, the second inner liner surface and the sidewall flute comprises applying a volume of adhesive to at least a portion of a plurality of flute surface contact portions.

13. The method of claim 12, wherein the at least a portion of a plurality of flute surface contact portions comprises one or more outer flute surface contact portions defined by an outer flute surface of the sidewall flute.

14. The method of claim 12, wherein the at least a portion of a plurality of flute surface contact portions comprises one or more inner flute surface contact portions defined by an inner flute surface of the sidewall flute.

15. The method of claim 10, further comprising curing the first outer coating layer and the second outer coating layer.

16. The method of claim 10, further comprising curing the first inner coating layer and the second inner coating layer.
